(19) United States
(12) Patent Application Publication
(10) Pub. No.: US 2026/0214748 A1
(43) Pub. Date: Jul. 23, 2026

(54) BROADCASTING AND MULTICASTING MECHANISMS IN A SWITCH DEVICE

(71) Applicant: MaxLinear, Inc., Carlsbad, CA (US)

(72) Inventor: Curtis Ling, Carlsbad, CA (US)

(73) Assignee: MaxLinear, Inc., Carlsbad, CA (US)

(21) Appl. No.: 19/397,699

(22) Filed: Nov. 21, 2025

Related U.S. Application Data
(60) Provisional application No. 63/723,566, filed on Nov. 21, 2024.

(51) Int. Cl. H04W 76/40; H04L 43/087

(52) U.S. Cl. CPC H04W 76/40; H04L 43/087

(57) ABSTRACT

A switch device may include: a first electronic device including a plurality of ports to facilitate communication via a plurality of lanes; a plurality of second electronic devices comprising a second plurality of ports, wherein the second electronic devices are operable to communicate with the first electronic device via the plurality of lanes; and a switch controller. The switch controller may: dynamically map the plurality of lanes from at least one port of the first electronic device to one or more ports of the second plurality of ports of the plurality of second electronic devices; facilitate simultaneous broadcasting of data from the at least one port of the first electronic device to a plurality of ports of the second electronic devices; and enable multicasting by selectively mapping data from the at least one port of the first electronic device to a predefined subset of ports in the second electronic devices.

### RELATED APPLICATION

This application claims the benefit of U.S. Provisional Application No. 63/723,566, filed November 21, 2024, the disclosure of which is incorporated herein by reference in its entirety.

The examples discussed in the present disclosure are related to broadcasting and multicasting mechanisms in a switch device.

### BACKGROUND

Unless otherwise indicated herein, the materials described herein are not prior art to the claims in the present application and are not admitted to be prior art by inclusion in this section.

Datacenters and AI clusters may use Ethernet switches that are packet switched. Using a packet switched Ethernet switch may result in delivery that is not reliable, is variable, and has high latency. Fabric switches may provide another possibility in datacenters and artificial intelligence (AI) clusters. Fabric switches, unlike Ethernet switches, may be equivalent to circuit-switched networks, rather than packet-switched networks.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

Some examples described herein include systems and methods for enhancing broadcasting and multicasting capabilities within crossbar switch architectures, addressing modern high-performance computing and networking systems. The examples herein enable efficient and synchronized distribution of data from one or more inputs to multiple outputs, ensuring optimal performance and scalability.

In some examples, systems include capability for broadcasting data from a single input to individual, some or all, output ports simultaneously, as well as multicasting capabilities that selectively transmit data to predefined subsets of output ports. To address synchronization challenges, the examples herein provide method for ensuring that data is delivered to multiple destinations without, or substantially without, or reduced, jitter, misalignment, or data integrity issues, maintaining performance across the system.

In some examples, load-balancing methods prevent congestion and resource bottlenecks during broadcasting and multicasting operations. By dynamically managing crossbar traffic in real-time, the systems and method of the examples herein balance workloads across multiple inputs and outputs, optimizing resource utilization and minimizing latency. Such systems and methods provide seamless scalability, making the architecture suitable for applications in data centers, telecommunications networks, artificial intelligence workloads, and other high-demand environments.

In an example, a switch device may include a first electronic device, multiple second electronic devices, and a switch controller. The first electronic device may include multiple ports operable to facilitate communication via multiple lanes. The second electronic devices may include multiple second ports and may communicate with the first electronic device via the multiple lanes. The switch controller may be configured to dynamically map the multiple lanes from at least one port of the first electronic device to one or more ports of the second multiple ports of the second electronic devices. The switch controller may be operable to facilitate simultaneous broadcasting of data from the at least one port of the first electronic device to multiple ports of the second electronic devices. The switch controller may be operable to enable multicasting by selectively mapping data from the at least one port of the first electronic device to a predefined subset of ports in the second electronic devices.

The objects and advantages of the examples will be realized and achieved at least by the elements, features, and combinations particularly pointed out in the claims. Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates an example switch device;

FIG. 2 illustrates an example circuit diagram of a switch device that may be used for broadcasting and/or multicasting;

FIG. 3 illustrates an example system including the switch device of FIG. 1;

FIG. 4 illustrates an example method for broadcasting and/or multicasting using a switch device;

FIG. 5 illustrates an example communication system operable for broadcasting and/or multicasting using a switch device; and

FIG. 6 illustrates a diagrammatic representation of a machine in the example form of a computing device within which a set of instructions, for causing the machine to perform any one or more of the methods discussed herein, may be executed.

FIG. 7A illustrates an example block diagram of a data center.

FIG. 7B illustrates an example switch device.

FIG. 7C illustrates an example switch device

FIG. 7D illustrates an example switch device.

### DETAILED DESCRIPTION

The present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single example, but other examples are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure.

Crossbar switch architectures may be used in high-performance computing, networking, and telecommunications systems due to their ability to provide flexible, scalable, and low-latency data routing between multiple input and output ports. Broadcasting and multicasting may enable the transmission of data from a single source to multiple destinations, either universally (broadcasting) or selectively (multicasting), without duplicating the data stream for each destination.

Implementations of broadcasting and multicasting in crossbar systems often rely on resource-intensive techniques, such as duplicating data streams or creating separate transmission paths for each output port. Such approaches can lead to inefficiencies, including increased power consumption, latency, and congestion within the crossbar switch. Additionally, synchronization challenges arise when transmitting data to multiple output ports simultaneously, as slight variations in propagation delays can lead to jitter, data misalignment, or integrity issues.

The examples described below provides systems and methods for enhancing broadcasting and multicasting capabilities within crossbar switch architectures, addressing challenges in modern high-performance computing and networking systems. The examples herein enable efficient and synchronized distribution of data from one or more inputs to multiple outputs, ensuring optimal performance and scalability, which is described in detail below.

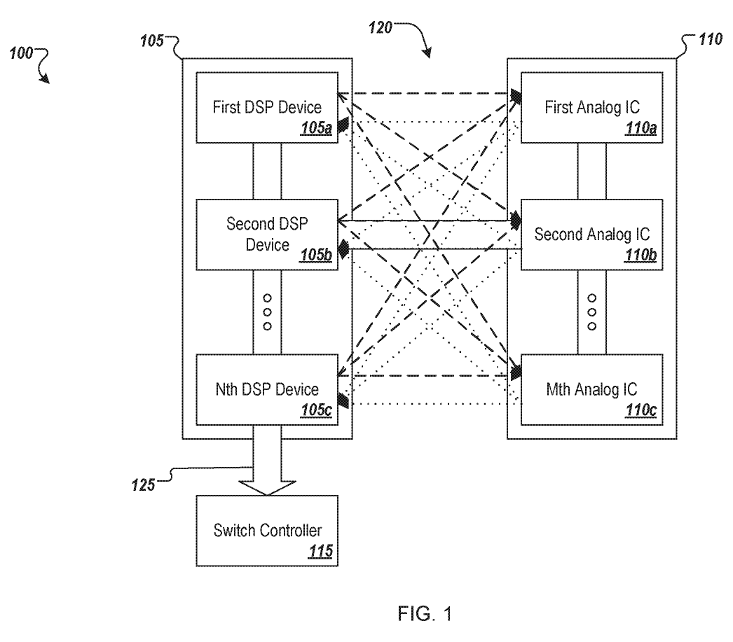

As illustrated in FIG. 1, a switch device 100 may be used to facilitate broadcasting and/or multicasting between components included in the switch device 100. The switch device 100 may include a first digital signal processor (DSP) device 105a, a second DSP device 105b, an nth DSP device 105c, referred to collectively as multiple first electronic devices 105, a first analog integrated circuit (IC) 110a, a second analog IC 110b, an mth analog IC 110c, referred to collectively as multiple second electronic devices 110, a switch controller 115, in-band traffic 120, and out-of-band traffic 125.

The switch device 100 may be reconfigurable (e.g., in terms of the connections between the components therein, such as the multiple first electronic devices 105 and the multiple second electronic devices 110, the switch controller 115, and/or a remote device 130), where the switching of the connections/lanes between the components may be low latency (e.g., less than 5 ns switching, less than 10 ns, or the like). Alternatively, or additionally, the switch device 100 may reconfigure without the use of retiming such that each lane of the multiple lanes included therein may use less than 50 mW of power. For example, each lane of the multiple lanes may support 100G bandwidth while using less than 50 mW of power.

The multiple first electronic devices 105 may each include one or more ports configured to facilitate seamless and efficient communications within the switch device 100. These communications may occur between the multiple first electronic devices 105, the multiple second electronic devices 110, and the switch controller 115. The communications may be carried out via multiple lanes included within the switch device 100, with each lane designed to handle distinct communication streams. These lanes enable the concurrent transmission and reception of data, thereby supporting both in-band traffic 120 (e.g., primary data streams such as user-generated or operational data) and out-of-band traffic 125 (e.g., control or management signals for device synchronization and configuration).

The communications facilitated by these lanes may include bidirectional data exchange, enabling simultaneous broadcasting and multicasting operations. Bidirectional communication allows data to flow in both directions between the transmitting and receiving devices, which is used for dynamic, real-time traffic scenarios. For instance, during a broadcast operation, a first port of a digital signal processor (DSP) device in the multiple first electronic devices 105 may transmit a data stream to multiple receiving ports across the multiple second electronic devices 110. At the same time, feedback data, such as acknowledgment signals or performance metrics, may flow back from the receiving ports to the transmitting DSP device or the switch controller 115, ensuring error correction and traffic optimization.

Moreover, during multicasting operations, where data is selectively routed to a predefined subset of ports, the bidirectional capability enables real-time adjustments to routing paths based on current traffic conditions. For example, the switch controller 115 may dynamically reallocate lanes or adjust transmission parameters based on feedback received from the second electronic devices 110. This facilitates efficient bandwidth usage, minimizes latency, and ensures that high-priority data streams are delivered promptly and accurately.

Additionally, the lanes may be designed to handle high-throughput data transmission, enabling each lane to support simultaneous high-speed operations. For example, in certain configurations, the lanes may support data rates sufficient for applications requiring 100G bandwidth while maintaining low power consumption per lane. This capability is particularly beneficial for scenarios requiring synchronized delivery of large data sets, such as real-time video broadcasting or parallel processing tasks in high-performance computing environments.

To further enhance reliability and efficiency, the switch device 100 may employ traffic management techniques. For example, lanes carrying in-band traffic 120 may prioritize data packets based on predefined quality-of-service (QoS) metrics, while out-of-band traffic 125 may manage synchronization, lane allocation, and fault-tolerant routing. Together, these mechanisms may ensure robust and scalable communication, accommodating both high-speed modern applications and adaptive broadcasting and multicasting systems.

The multiple lanes between the multiple first electronic devices 105 and the multiple second electronic devices 110 may be in an any-to-any configuration. For example, the first DSP device 105a may include a lane to the first analog IC 110a, to the second analog IC 110b, and/or the nth analog IC 110c. A similar arrangement may be for each of the multiple first electronic devices 105, such that each DSP device of the multiple first electronic devices 105 may include a lane to any number of the multiple second electronic devices 110, including none of the multiple second electronic devices 110. As illustrated in FIG. 1, each lane for facilitating the in-band traffic 120 is both directions (e.g., transmit and receive) between the multiple first electronic devices 105, the multiple second electronic devices 110, and/or a remote device 130. Alternatively, or additionally, the lanes are dashed/dotted to illustrate that for any transmit/receive path between the multiple first electronic devices 105, the multiple second electronic devices 110, and/or a remote device 130, a lane may or may not be present.

The multiple first electronic devices 105 may be digital signal processors (DSPs) and/or the multiple second electronic devices 110 may be analog circuit switch integrated circuits (ICs) for use with electrical signals. Alternatively, or additionally the multiple second electronic devices 110 may be analog optical circuit switch ICs for use with optical signals.

The multiple second electronic devices 110 may individually include one or more ports that may be used to facilitate communications within the switch device 100, similar to the ports described relative to the multiple first electronic devices 105. Alternatively, or additionally, the lanes for communications between the multiple first electronic devices 105 and the multiple second electronic devices 110 may be coupled with the ports included in the multiple second electronic devices 110.

The switch controller 115 may be a microcontroller unit (MCU). Alternatively, or additionally, the switch controller 115 may be a DSP, or other processing device. The switch controller 115 may be communicatively coupled with at least the multiple first electronic devices 105 and/or the multiple second electronic devices 110. The switch controller 115 may resolve resource grant requests, distribute the network state to the multiple first electronic devices 105 and/or to the multiple second electronic device 110, and/or may establish and/or maintain timing among the components included in the switch device 100.

The switch controller 115 may be programmable to dynamically map lanes between the multiple first electronic devices 105 and the multiple second electronic devices 110. This dynamic mapping allows the switch controller 115 to optimize system performance by reconfiguring lanes in real-time based on operating conditions. For example, the switch controller 115 may be configured to optimize energy efficiency by deactivating unused lanes during idle periods, thereby reducing power consumption. Additionally, in instances where a lane failure is detected, the switch controller 115 may reroute data through one or more redundant lanes to maintain uninterrupted communication and ensure fault tolerance.

For instance, if the first DSP device 105a includes a lane to the first analog IC 110a, the switch controller 115 may dynamically remap the connection to redirect the lane to the second analog IC 110b. This capability enables flexible and adaptive reconfiguration of the system, ensuring efficient utilization of available lanes and resources.

Furthermore, the switch controller 115 may dynamically adapt lane mappings based on real-time traffic conditions or predefined thresholds. For example, when the volume of data traffic handled by one of the multiple first electronic devices 105 or the multiple second electronic devices 110 satisfies or exceeds a predefined threshold, the switch controller 115 may redistribute traffic across alternate lanes to prevent congestion and maintain high performance. This adaptability ensures the system can handle varying workloads and maintain quality of service.

Such programmable dynamic mapping not only enhances the reliability and scalability of the switch device 100 but also supports advanced functionalities like load balancing, congestion avoidance, and energy-efficient operation. By leveraging intelligent traffic management and real-time reconfiguration, the switch controller 115 ensures the system remains robust and efficient under diverse operating conditions. The switch controller 115 may facilitate a broadcast of data within the switch device 100. The broadcast may include transmitting data from a first port of a particular DSP device of the multiple first electronic devices 105 to multiple ports associated with the multiple second electronic devices 110. For example, the switch controller 115 may direct a first port of the first DSP device 105a to broadcast data to a port in the first analog IC 110a, the second analog IC 110b, and the nth analog IC 110c. The switch controller 115 may direct one or more lanes from a port of the broadcasting device (e.g., the first DSP device 105a in the example) be mapped to multiple lanes associated with multiple ports across one or more receiving devices (e.g., the multiple second electronic devices 110 in the example).

The switch controller 115 may implement adaptive load balancing during broadcasting as described. The switch controller 115 may distribute traffic between the lanes utilized as part of the broadcast, such that each lane may communicate an approximately equal amount of data. The adaptive distribution of traffic across the lanes may reduce and/or eliminate resource contention within the switch device 100. Alternatively, or additionally, the switch controller 115 may direct each lane included in the broadcast to transmit the same or similar data, such that each receiving port (e.g., the multiple ports associated with the multiple second electronic devices 110) may receive substantially the same data as one another and/or as transmitted from the transmitting port (e.g., the port associated with one of the multiple first electronic devices 105).

The switch controller 115 may dynamically reallocate lanes between the multiple first electronic devices 105 and the multiple second electronic devices 110, such as during a broadcast, a multicast, and/or other communications within the switch device 100. The reallocation of lanes may be in response to traffic conditions in the switch device 100. For example, in instances in which the switch controller 115 detects congestion in one or more lanes used for a broadcast, the switch controller 115 may adaptively map a new lane to replace the congested lane used in the broadcast. In another example, the switch controller 115 may determine a fault condition within one or more of the lanes used in a broadcast and in response, the switch controller 115 may adaptively map a new lane to replace the lane experiencing a fault condition. The switch controller 115 may be configured to adaptively reallocate any of the lanes included in the switch device 100 based on conditions within the switch device 100, user configurations, and/or other information obtained by the switch controller 115.

The switch controller 115 may facilitate multicasting within the switch device 100. Multicasting may include selectively mapping one or more lanes from a transmitting port (e.g., a port associated with a DSP device of the multiple first electronic devices 105) to a predefined subset of ports (e.g., a set of ports associated with one or more of the multiple second electronic devices 110). For example, a first multicast may define a mapping of lanes from a first port of the first DSP device 105a to a set of ports of the multiple second electronic devices 110, such as a first port of the first analog IC 110a and a second port of the second analog IC 110b. The switch controller 115 may selectively map any number of lanes from a port associated with a DSP device of the multiple first electronic devices 105 to multiple ports associated with one or more analog ICs of the multiple second electronic devices 110.

The predefined subset of ports used for multicasting may be dynamically varied based on data collected and analyzed by the switch controller 115. For instance, the switch controller 115 may modify the subset of ports for multicasting in response to real-time traffic analysis, ensuring efficient distribution of data and minimizing latency. This real-time analysis allows the switch controller 115 to identify and address bottlenecks, rerouting data to optimize system performance.

Additionally, the switch controller 115 may adjust the predefined subset of ports based on a set of routing rules stored within or defined for the controller. These routing rules could include criteria such as prioritizing certain devices, optimizing bandwidth usage, or ensuring specific data delivery pathways for high-priority applications. For example, the switch controller 115 might prioritize multicast delivery to ports serving network segments while deprioritizing less useful destinations during high-traffic conditions.

User-defined configurations may also influence the predefined subset of ports for multicasting. For example, network administrators could specify selected routing paths, priority devices, or bandwidth allocations through a user interface or configuration file. The switch controller 115 may then adapt the multicasting configuration to align with these user-defined parameters, offering a customizable and flexible solution tailored to specific operations.

Similar to the handling of broadcast functionality, the switch controller 115 may dynamically reallocate one or more lanes in response to adverse conditions during multicasting. For instance, if congestion is detected in one or more lanes associated with a multicast operation, the switch controller 115 may redirect data through alternative lanes to alleviate the bottleneck. Likewise, if a fault condition is identified in a lane, the controller can dynamically remap the multicast traffic to a redundant or unused lane, ensuring seamless and reliable data transmission. This dynamic adaptation enhances the system's resilience, scalability, and overall efficiency.

The switch controller may be configured to synchronize broadcasting operations to ensure the simultaneous delivery of data to all targeted ports, enabling coordinated data transmission across the switch device. Such synchronization may include clock alignment across the first electronic device, the second electronic devices, and the plurality of lanes. Additionally, buffering mechanisms may be employed to equalize data arrival times at different ports, minimizing jitter and ensuring reliable data delivery.

Clock alignment may be achieved through a combination of centralized control, adaptive synchronization mechanisms, and precise timing adjustments, ensuring that all components in the switch device operate in harmony. The switch controller may serve as the central timing source, distributing a reference clock signal to the first electronic device, the second electronic devices, and the plurality of lanes. This centralized clock minimizes discrepancies that may arise from independent timing sources within the system. A clock distribution network may be used to propagate the timing signal across all components, ensuring minimal skew or variations caused by differences in signal path lengths or propagation delays.

To further enhance synchronization, components such as digital signal processors (DSPs) and integrated circuits (ICs) include phase-locked loops (PLLs) or similar circuitry, which adjust the phase and frequency of local oscillators to match the reference clock signal distributed by the switch controller. These mechanisms allow for precise alignment with the centralized timing reference, even in scenarios where minor variations in signal propagation may occur. Synchronous communication protocols may be implemented within the switch device, embedding timing information directly within transmitted data. This embedded timing information may enable receiving devices to recover the clock signal and align their operations with the overall system timing.

Buffering mechanisms and timing adjustment logic may be integrated into the system to address variations in data arrival times across the plurality of lanes. For example, first-in-first-out (FIFO) buffers temporarily store incoming data, allowing timing adjustments to align data streams with the central clock. The switch controller may dynamically compensate for skew by employing adjustable delay lines and calibration algorithms, ensuring that all signals remain synchronized at their destinations. In addition, clock synchronization protocols, such as those based on the IEEE 1588 standard or similar methods, facilitate precise timing coordination among the components of the switch device.

To maintain alignment under varying conditions, the system may incorporate feedback loops that allow individual components to report timing discrepancies back to the switch controller. Based on this feedback, the switch controller may dynamically fine-tune timing signals or adjust synchronization parameters to maintain alignment. These mechanisms may collectively enable seamless broadcasting and multicasting operations, ensuring simultaneous delivery of data to all targeted ports with minimal jitter or latency, even under high traffic or adverse conditions. By achieving robust clock alignment, efficient and reliable operation of the switch device may be facilitated, meeting the stringent operations of modern high-performance computing and networking systems.

To reduce overhead during broadcasting and multicasting, the switch controller may compress data streams prior to transmission, thereby conserving bandwidth. Caching mechanisms may be utilized to store frequently broadcasted data, reducing redundancy and improving overall efficiency. Furthermore, the switch controller may allocate reserved bandwidth for high-priority multicast or broadcast traffic, ensuring that data is delivered promptly and without interruption.

The dynamic mapping performed by the switch controller may be configured to optimize operational efficiency and reliability. For example, the switch controller may deactivate unused lanes during idle periods to conserve energy. In instances where a lane failure is detected, the switch controller may dynamically reroute data through one or more redundant lanes, maintaining seamless communication and minimizing disruptions within the system.

The switch device 100 may include one or more redundant lanes that may be used in various situations during operation of the switch device 100. For example, one or more redundant lanes may be used for the out-of-band traffic 125, such as signaling using the out-of-band traffic 125. In such instances, the out-of-band signaling may be transmitted and/or received by a particular DSP device and/or by the switch controller 115, and the out-of-band signaling may be a lower transmission rate than the in-band traffic 120. In another example, one or more redundant lanes may be used for out-of-bandwidth broadcasts from the switch controller 115 and/or from one or more of the multiple first electronic devices 105 to other devices in the switch device 100 (e.g., such as other DSP devices).

The switch controller 115 may be configured to reserve a portion of bandwidth associated with the in-band traffic 120 in the switch device 100. The bandwidth reserved by the switch controller 115 may be reserved on a per lane basis of the multiple lanes included in the switch device 100. For example, a first lane between the first DSP device 105a and the first analog IC 110a may have a first reserved bandwidth and a second lane between the second DSP device 105b and the second analog IC 110b may have a second reserved bandwidth, where the amount of bandwidth reserved may be the same or may differ between the first reserved bandwidth and the second reserved bandwidth. The switch controller 115 may allocate resources within the switch device 100 based on predicted or anticipated traffic (e.g., based on a probabilistic model).

Alternatively, or additionally, the switch controller 115 may monitor each lane of the multiple lanes within the switch device 100 to ensure optimal performance and reliability. The monitoring may occur periodically, in a round-robin fashion, or dynamically based on traffic conditions, allowing the switch controller 115 to evaluate the operational status of each lane in real time. This process enables the detection of failures, signal degradation, or other adverse conditions that may impact data transmission. Upon identifying a lane experiencing degradation that exceeds a predefined threshold for acceptable performance, the switch controller 115 may dynamically remap traffic to an alternate lane within the switch device 100, ensuring uninterrupted communication and preserving data integrity.

To enhance operational efficiency, the switch controller 115 may be configured to dynamically analyze real-time traffic patterns across all lanes. This analysis allows for the adjustment of lane mappings to optimize bandwidth allocation, especially during broadcasting or multicasting operations. By actively redistributing traffic, the switch controller 115 minimizes congestion, mitigates latency, and ensures balanced utilization of system resources. Furthermore, the switch controller 115 may use sophisticated algorithms to detect potential bottlenecks or inefficiencies, enabling proactive remapping to maintain seamless communication with minimal jitter and delay.

These capabilities may be supported by integrated feedback mechanisms, which provide the switch controller 115 with continuous updates on lane conditions, signal quality, and traffic metrics. Based on this feedback, the switch controller dynamically reallocates lanes and recalibrates routing pathways to adapt to evolving network conditions. This adaptive monitoring and remapping functionality not only enhances the system's resilience but also ensures high-performance data transmission, making the switch device 100 well-suited for demanding broadcasting and multicasting applications.

The switch controller 115 may communicate with the multiple first electronic devices 105 and/or the multiple second electronic devices 110 using a separate connection/lane than the connections between the multiple first electronic devices 105 and the multiple second electronic devices 110. For example, the first connection between the multiple first electronic devices 105 and the multiple second electronic devices 110 may facilitate the in-band traffic 120 and the second connection between the switch controller 115 and the multiple first electronic devices 105 and/or the multiple second electronic devices 110 may facilitate the out-of-band traffic 125.

The out-of-band traffic 125 may use a different network than the in-band traffic 120. Alternatively, or additionally, the out-of-band traffic 125 may use a different physical layer protocol than the in-band traffic 120. The out-of-band traffic 125 may be used to manage and/or configure one or more components included in the switch device 100. For example, the switch controller 115 may communicate with the multiple first electronic devices 105 using the out-of-band traffic 125 to reconfigure lanes and/or traffic routing based on the traffic through the switch device 100.

Modifications, additions, or omissions may be made to the switch device 100 without departing from the scope of the present disclosure. For example, the designations of different elements in the manner described is meant to help explain concepts described herein and is not limiting. Further, the switch device 100 may include any number of other elements or may be implemented within other systems or contexts than those described. For example, any of the components of FIG. 1 may be divided into additional or combined into fewer components.

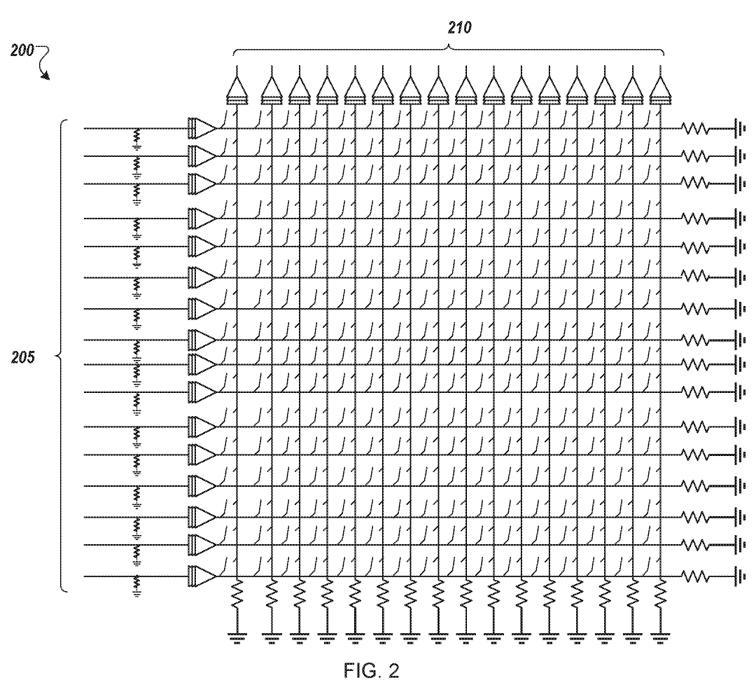

As illustrated in FIG. 2, the circuit diagram 200 depicts an example configuration of a switch device designed for broadcasting and/or multicasting operations. The circuit is structured with a matrix architecture that includes multiple input lanes 205 and output lanes 210, forming a highly adaptable crossbar network. The input lanes and output lanes are interconnected through a series of switching nodes, each capable of directing traffic dynamically between any input and any output. This matrix design enables flexible data distribution across the network while optimizing resource utilization.

Each input lane may be equipped with signal conditioning elements, such as termination resistors (e.g., 50 Ω and 75 Ω), to ensure impedance matching and minimize signal reflection or degradation. Additionally, the circuit may incorporate retimers placed strategically along the signal paths. These retimers may regenerate the signal by restoring its timing and amplitude characteristics, ensuring data integrity during transmission. Retimers may be valuable for high-speed operations and long-distance transmissions where signal degradation can occur.

The switch nodes in the crossbar network are controlled by the switch controller, which dynamically maps input lanes to output lanes based on real-time traffic. The switching mechanism allows individual input lanes to be connected to multiple output lanes simultaneously for broadcasting or selectively to a predefined subset of output lanes for multicasting. This dynamic mapping ensures efficient use of the network and supports high-throughput applications.

To achieve power efficiency, the circuit may be designed with mechanisms to switch input and output lanes on or off. For example, during periods of inactivity or reduced traffic, unused lanes can be deactivated to conserve power. This power management strategy not only reduces energy consumption but also minimizes heat generation, enhancing the overall efficiency and reliability of the system. Moreover, the ability to reroute traffic around inactive lanes or failed components ensures continued operation without significant degradation in performance.

The circuit may also include selective buffers along the signal paths from the inputs to the outputs. The selective buffers (not shown) may isolate each switch from each subsequent switch. Each row may activate the buffers that are used to provide isolation to the switches.

The use of such a crossbar configuration, with programmable mapping and energy-efficient features, enables the switch device to handle diverse broadcasting and multicasting scenarios. These include simultaneous data transmission to multiple endpoints and targeted delivery to select nodes, all while maintaining minimal latency and jitter. The inclusion of termination resistors and retimers further enhances signal quality, making the system robust and reliable for high-speed data communications. This architecture may be used for applications having dynamic reconfiguration and load balancing, such as in data centers, telecommunications, and high-performance computing networks.

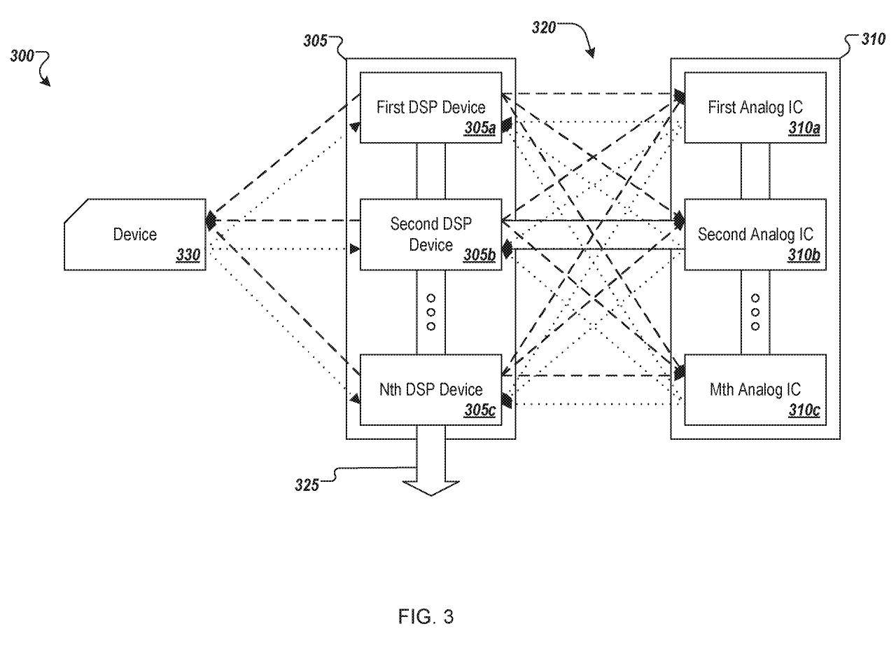

As shown in FIG. 3, the system 300 provides an implementation of the switch device 100 described in FIG. 1, optimized for supporting broadcasting and multicasting operations. The system architecture may be structured around multiple first electronic devices 305, including a first digital signal processor (DSP) device 305a, a second DSP device 305b, and an nth DSP device 305c, which may work in tandem with multiple second electronic devices 310, such as a first analog integrated circuit (IC) 310a, a second analog IC 310b, and an mth analog IC 310c. These components may be interconnected through a highly flexible and scalable network of communication lanes. The system may include a switch controller, which may govern the dynamic mapping of input lanes to output lanes, enabling efficient data flow for broadcasting and multicasting.

System 300 may facilitate both in-band traffic 320 and out-of-band traffic 325, ensuring robust and synchronized communication across its architecture. The in-band traffic 320 pertains to the primary data exchange operations, such as broadcasting and multicasting, while the out-of-band traffic 325 may be used for control signals and network management tasks. The switch controller may play a role in managing these traffic types, dynamically configuring the system to optimize performance based on real-time.

For example, the multiple electronic devices 305 may act as the primary processing units, each equipped with multiple ports for sending and receiving data. These DSP devices may be connected to the multiple second electronic devices 310, which may serve as the interface for analog signal processing and distribution. The interconnection between the DSP devices and analog ICs may be achieved through a network of lanes, which the switch controller dynamically maps to accommodate different broadcasting and multicasting scenarios. This mapping may allow the system to transmit data from a single source (e.g., a DSP device) to multiple destinations (e.g., analog ICs) simultaneously, as in broadcasting, or selectively to predefined subsets of destinations, as in multicasting.

System 300 may be designed to communicate seamlessly with external devices, such as the remote device 330. The remote device 330 may interface with the system through one or more communication channels, allowing it to send and receive data via the switch device 100. This external communication capability may allow the system to extend its broadcasting and multicasting functionalities to devices outside the local network, enhancing its utility in distributed computing environments, data centers, and telecommunications networks.

Advantageously, the system may dynamically adjust to changing network conditions. The switch controller may monitor the state of the lanes and dynamically reallocate resources to ensure optimal performance. For instance, during a broadcasting operation, if the switch controller detects congestion or a fault in one of the lanes, it can remap the data flow to an alternate lane, maintaining uninterrupted communication. Similarly, during multicasting, the switch controller may modify the predefined subset of output ports based on real-time traffic analysis, routing rules, or user-defined configurations.

The integration of both in-band and out-of-band traffic may further enhance the system's efficiency. By separating control and management signals from primary data traffic, the system may minimize interference and ensures low latency in data transmission. Additionally, the use of out-of-band traffic may allow the switch controller to perform network management tasks, such as lane monitoring and fault detection, without impacting the operations of broadcasting and multicasting.

Thus, system 300 represents a robust and versatile implementation of the switch device 100, capable of handling complex broadcasting and multicasting operations with high efficiency and reliability. Its dynamic mapping capabilities, combined with its seamless integration of in-band and out-of-band traffic, make it well-suited for a wide range of applications, including high-performance computing, data center networking, and next-generation communication systems.

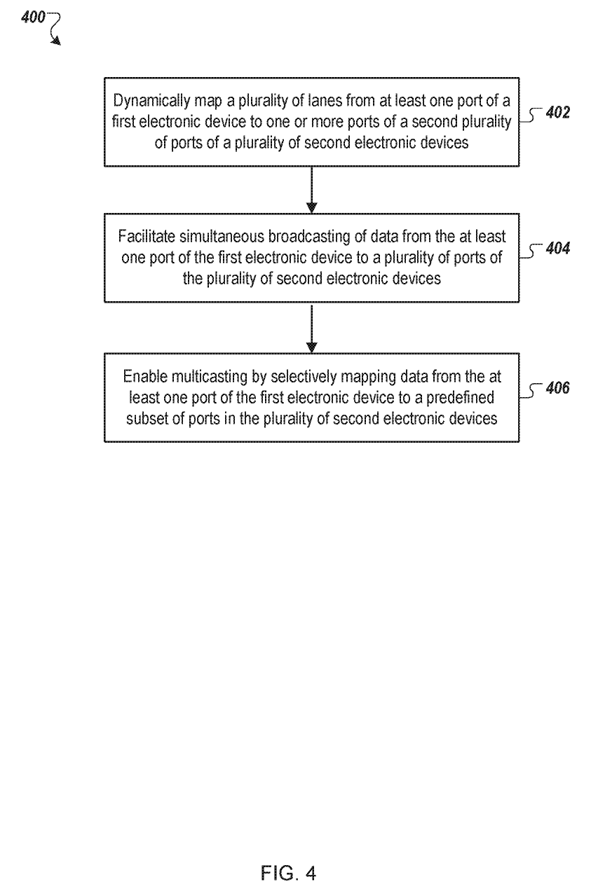

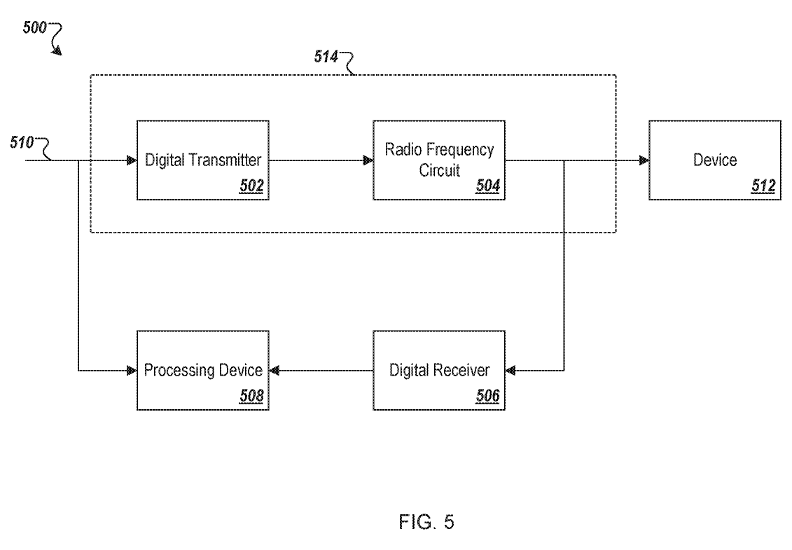

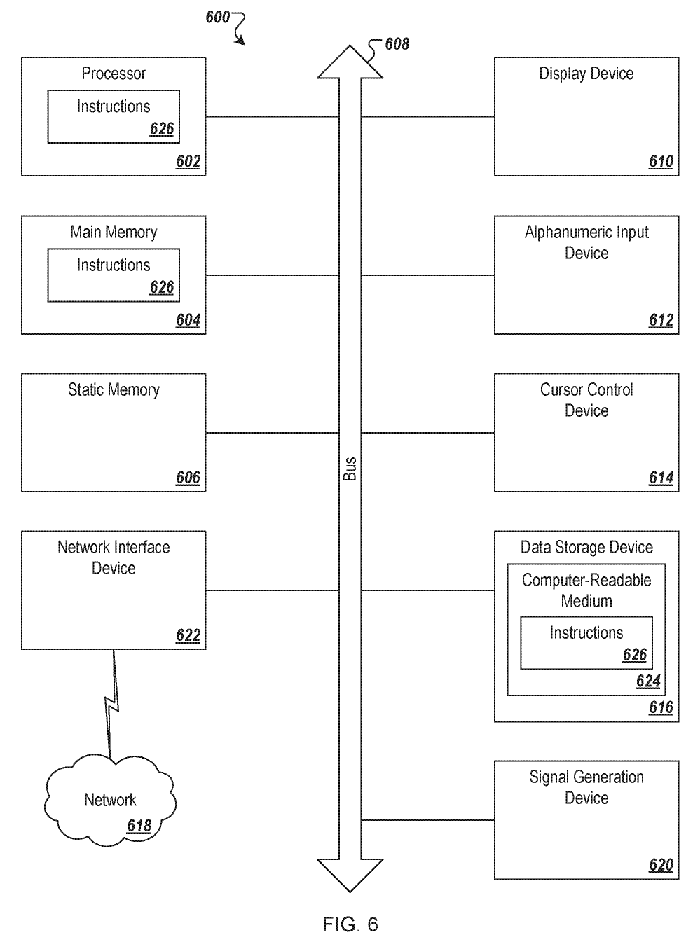

The method 400 depicted in FIG. 4 outlines a sequence of operations that may be executed by processing logic, which may be implemented in hardware, software, or a combination of both. The processing logic may be incorporated in various systems, such as the processing device 602 shown in FIG. 6, the communication system 500 illustrated in FIG. 5, or other devices or system configurations capable of handling high-performance broadcasting and multicasting.

The method includes block 402, where the processing logic dynamically maps multiple lanes from at least one port of a first electronic device (e.g., a DSP device) to one or more ports of second multiple ports of multiple second electronic devices (e.g., analog ICs). This dynamic mapping enables the system to establish flexible and efficient communication pathways between the input and output devices. The mapping is not static but instead adapts to network conditions, such as traffic load, congestion, or fault detection, to ensure optimal lane utilization and minimize disruptions. By leveraging real-time traffic analysis and predefined routing algorithms, the system ensures that the dynamic mapping process aligns with performance, such as low latency and high throughput.

At block 404, the method facilitates simultaneous broadcasting of data from the at least one port of the first electronic device to multiple ports of the multiple second electronic devices. During this process, the processing logic provides that a single input data stream is distributed to designated output ports. To achieve this, the processing logic may utilize clock alignment techniques and buffering mechanisms to synchronize data delivery across the lanes, thereby eliminating jitter and ensuring data integrity at all receiving ports. Additionally, the broadcasting operation incorporates adaptive load-balancing strategies to distribute traffic evenly across the available lanes, preventing resource contention and maximizing system efficiency.

At block 406, the method enables multicasting by selectively mapping data from the at least one port of the first electronic device to a predefined subset of ports in the multiple second electronic devices. Unlike broadcasting, where data is sent to all designated outputs, multicasting involves targeting specific subsets of output ports based on user-defined configurations, routing rules, or real-time traffic analysis. The processing logic dynamically adjusts the mappings to accommodate changes in network conditions, such as varying traffic loads or fault conditions in specific lanes. The ability to selectively and dynamically configure multicast groups ensures that the system can handle diverse communication scenarios while optimizing bandwidth utilization and minimizing latency.

The method 400 is designed to operate in a highly adaptive and efficient manner, leveraging advanced control mechanisms embedded within the switch controller to manage complex broadcasting and multicasting operations. Each of these blocks may incorporate sophisticated logic for monitoring and adjusting system parameters in real-time, ensuring the system's responsiveness to changing demands. Furthermore, the method integrates seamlessly with additional functionalities, such as lane redundancy, fault tolerance, and energy efficiency, to deliver robust performance across a wide range of applications, including high-speed data centers, telecommunications networks, and distributed computing systems.

The operations performed in blocks 402, 404, and 406 exemplify scalable approach employed by the system, enabling it to support modern networking while maintaining high levels of reliability, flexibility, and performance.

As illustrated in FIG. 5, an example communication system 500 may be configured for broadcasting and/or multiplexing in a switch device. The communication system 500 may include a digital transmitter 502, a radio frequency circuit 504, a device 512, a digital receiver 506, and a processing device 508. The digital transmitter 502 and the processing device may be configured to receive a baseband signal via connection 510. A transceiver 514 may comprise the digital transmitter 502 and the radio frequency circuit 504.

In some examples, the communication system 500 may include a system of devices that may be configured to communicate with one another via a wired or wireline connection. For example, a wired connection in the communication system 500 may include one or more Ethernet cables, one or more fiber-optic cables, and/or other similar wired communication mediums. Alternatively, or additionally, the communication system 500 may include a system of devices that may be configured to communicate via one or more wireless connections. For example, the communication system 500 may include one or more devices configured to transmit and/or receive radio waves, microwaves, ultrasonic waves, optical waves, electromagnetic induction, and/or similar wireless communications. Alternatively, or additionally, the communication system 500 may include combinations of wireless and/or wired connections. In these and other examples, the communication system 500 may include one or more devices that may be configured to obtain a baseband signal, perform one or more operations to the baseband signal to generate a modified baseband signal, and transmit the modified baseband signal, such as to one or more loads.

In some examples, the communication system 500 may include one or more communication channels that may communicatively couple systems and/or devices included in the communication system 500. For example, the transceiver 514 may be communicatively coupled to the device 512.

In some examples, the transceiver 514 may be configured to obtain a baseband signal. For example, as described herein, the transceiver 514 may be configured to generate a baseband signal and/or receive a baseband signal from another device. In some examples, the transceiver 514 may be configured to transmit the baseband signal. For example, upon obtaining the baseband signal, the transceiver 514 may be configured to transmit the baseband signal to a separate device, such as the device 512. Alternatively, or additionally, the transceiver 514 may be configured to modify, condition, and/or transform the baseband signal in advance of transmitting the baseband signal. For example, the transceiver 514 may include a quadrature up-converter and/or a digital to analog converter (DAC) that may be configured to modify the baseband signal. Alternatively, or additionally, the transceiver 514 may include a direct radio frequency (RF) sampling converter that may be configured to modify the baseband signal.

In some examples, the digital transmitter 502 may be configured to obtain a baseband signal via connection 510. In some examples, the digital transmitter 502 may be configured to up-convert the baseband signal. For example, the digital transmitter 502 may include a quadrature up-converter to apply to the baseband signal. In some examples, the digital transmitter 502 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 502.

In some examples, the transceiver 514 may include one or more subcomponents that may be used in preparing the baseband signal and/or transmitting the baseband signal. For example, the transceiver 514 may include an RF front end (e.g., in a wireless environment) which may include a power amplifier (PA), a digital transmitter (e.g., 502), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 504) of the transceiver 514 may be synchronized with the resource controller via the S-plane device, which may contribute to high-accuracy timing with respect to a reference clock.

In some examples, the transceiver 514 may be configured to obtain the baseband signal for transmission. For example, the transceiver 514 may receive the baseband signal from a separate device, such as a signal generator. For example, the baseband signal may come from a transducer configured to convert a variable into an electrical signal, such as an audio signal output of a microphone picking up a speaker’s voice. Alternatively, or additionally, the transceiver 514 may be configured to generate a baseband signal for transmission. In these and other examples, the transceiver 514 may be configured to transmit the baseband signal to another device, such as the device 512.

In some examples, the device 512 may be configured to receive a transmission from the transceiver 514. For example, the transceiver 514 may be configured to transmit a baseband signal to the device 512.

In some examples, the radio frequency circuit 504 may be configured to transmit the digital signal received from the digital transmitter 502. In some examples, the radio frequency circuit 504 may be configured to transmit the digital signal to the device 512 and/or the digital receiver 506. In some examples, the digital receiver 506 may be configured to receive a digital signal from the RF circuit and/or send a digital signal to the processing device 508.

In some examples, the processing device 508 may be a standalone device or system, as illustrated. Alternatively, or additionally, the processing device 508 may be a component of another device and/or system. For example, in some examples, the processing device 508 may be included in the transceiver 514. In instances in which the processing device 508 is a standalone device or system, the processing device 508 may be configured to communicate with additional devices and/or systems remote from the processing device 508, such as the transceiver 514 and/or the device 512. For example, the processing device 508 may be configured to send and/or receive transmissions from the transceiver 514 and/or the device 512. In some examples, the processing device 508 may be combined with other elements of the communication system 500.

FIG. 6 illustrates a diagrammatic representation of a machine in the example form of a computing device 600 within which a set of instructions, for causing the machine to perform any one or more of the methods discussed herein, may be executed. The computing device 600 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 600 includes a processing device (e.g., a processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

Processing device 602 represents one or more general-purpose processing devices such as a microprocessor, central processing unit, or the like. More particularly, the processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also include one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse) and a signal generation device 620 (e.g., a speaker). In at least one example, the display device 610, the alphanumeric input device 612, and the cursor control device 614 may be combined into a single component or device (e.g., an LCD touch screen).

The data storage device 616 may include a computer-readable storage medium 624 on which is stored one or more sets of instructions 626 embodying any one or more of the methods or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 618 via the network interface device 622.

While the computer-readable storage medium 624 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

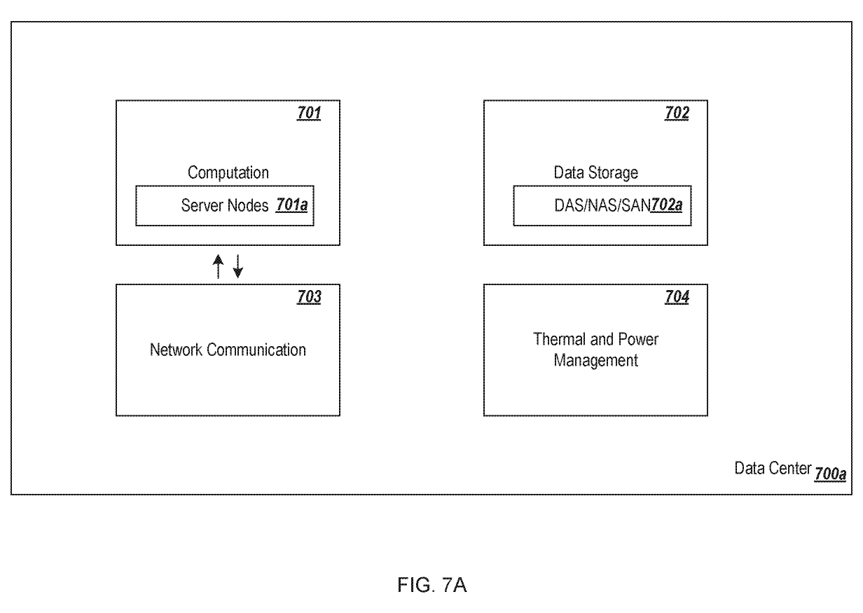

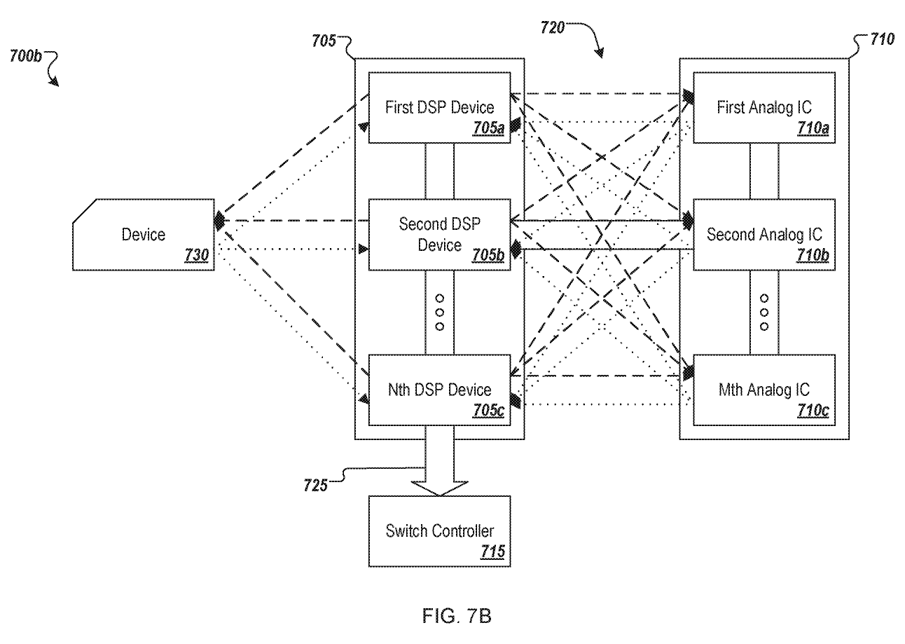

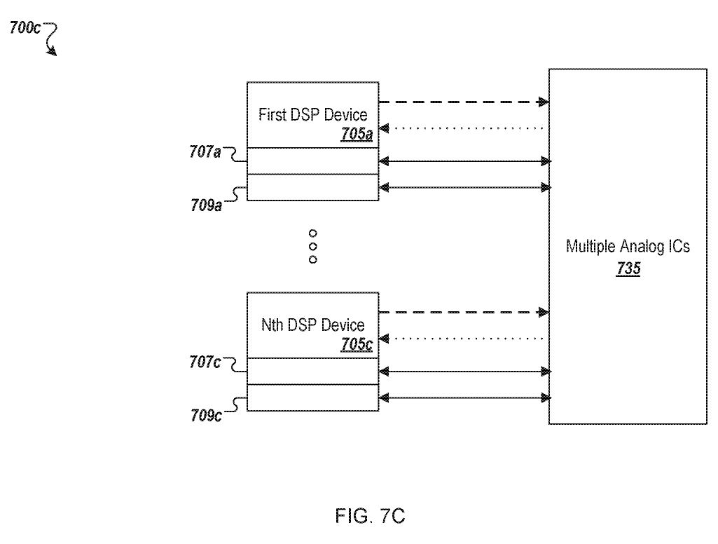

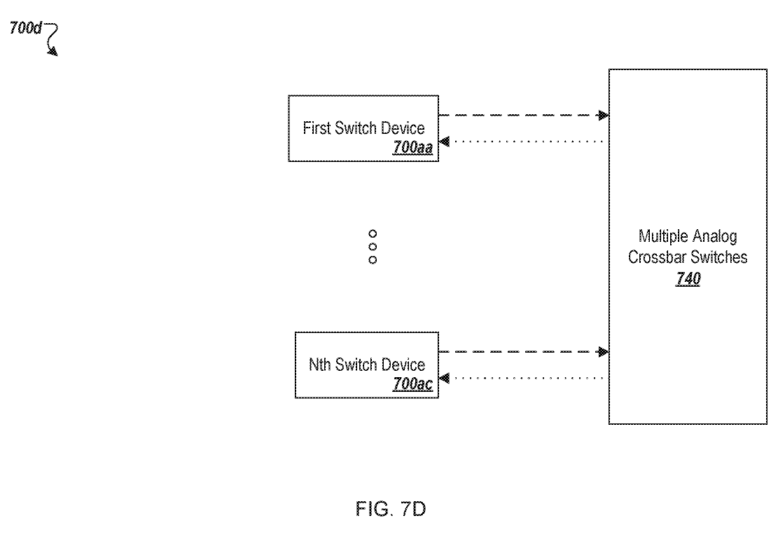

As illustrated in FIG. 7, a block diagram of a data center 700a may include multiple subsystems configured to perform various operational functions, including computation 701, data storage 702, network communication 703, and thermal and power management 704. The computation 701 subsystem may include one or more server nodes 701a that may execute software applications and process data workloads. The data storage 702 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 702a. The networking communication 703 subsystem may facilitate bidirectional data transfer between servers and external networks through high-speed switching and routing components. The thermal and power management 704 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 700a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as all traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18compute trays consuming about 6kW each, and 9 switch trays consuming about 1kW each. Each GPU may have 18 ports of 100GB/s each (or 1.8TB/s per GPU), and the rack network (which may be implemented using a copper backplane) may connect each GPU to the 9 switch trays to provide each GPU with the ability to deliver all of its 1.8TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch SOCs with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, 1/5 of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5ns, 10ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 7B illustrates an example switch device 700b. The switch device 700b may include a first digital signal processor (DSP) device 705a, a second DSP device 705b, an nth DSP device 705c, referred to collectively as multiple first electronic devices 705, a first analog integrated circuit (IC) 710a, a second analog IC 710b, an mth analog IC 710c, referred to collectively as multiple second electronic devices 710, a switch controller 715, in-band traffic 720, and out-of-band traffic 725. First DSP 705a, second DSP 705b, and nth DSP 705c may have input and output as shown in greater detail with respect to FIG. 2.

The switch device 700b may be reconfigurable (e.g., in terms of the connections between the components therein, such as the multiple first electronic devices 705 and the multiple second electronic devices 710, the switch controller 715, and/or a device 730), where the switching of the connections/lanes between the components may be low latency (e.g., less than 5ns, 10ns, or the like switching). Alternatively, or additionally, the switch device 700b may reconfigure without the use of retiming such that each lane of the multiple lanes included therein may use less than 50 mW of power. For example, each lane of the multiple lanes may support 100G bandwidth while using less than 50 mW of power.

The multiple first electronic devices 705 may individually include one or more ports that may be used to facilitate communications within the switch device 700b, such as between the multiple first electronic devices 705 and the multiple second electronic devices 710, the switch controller 715, and/or a device 730. The communications in the switch device 700b may be transmitted via multiple lanes in the switch device 700b. The multiple lanes may facilitate the in-band traffic 720 and/or the out-of-band traffic 725.

The multiple lanes between the multiple first electronic devices 705 and the multiple second electronic devices 710 may be in an any-to-any configuration. For example, the first DSP device 705a may include a lane to the first analog IC 710a, to the second analog IC 710b, and/or the mth analog IC 710c. A similar arrangement may occur for each of the multiple first electronic devices 705, such that each DSP device of the multiple first electronic devices 705 may include a lane to any number of the multiple second electronic devices 710, including none of the multiple second electronic devices 710. As illustrated in FIG. 7, each lane for facilitating the in-band traffic 720 may be in both directions (e.g., transmit and receive) between the multiple first electronic devices 705, the multiple second electronic devices 710, and/or a device 730. Alternatively, or additionally, the lanes are dashed/dotted to illustrate that for any transmit/receive path between the multiple first electronic devices 705, the multiple second electronic devices 710, and/or a device 730, a lane may or may not be present.

The multiple first electronic devices 705, the multiple second electronic devices 710, and/or the switch controller 715 may be disposed on a printed circuit board (PCB) where traces on the PCB may be used to connect at least the multiple first electronic devices 705, the multiple second electronic devices 710, and/or the switch controller 715 (e.g., the traces on the PCB may facilitate the in-band traffic 720 and/or the out-of-band traffic 725 in the switch device 700b). Alternatively, or additionally, the multiple first electronic devices 705, the multiple second electronic devices 710, and/or the switch controller 715 may be connected to one another using connectors, such as high-speed cables, where the multiple first electronic devices 705, the multiple second electronic devices 710, and/or the switch controller 715 may individually include ports/headers to support the use of the connectors. In instances in which the connectors are used, crosstalk between the multiple lanes in the switch device 700b may be reduced relative to the crosstalk that may occur when the switch device 700b uses traces on a PCB.

The switch device 700b, including the multiple first electronic devices 705, the multiple second electronic devices 710, and/or the switch controller 715, may be utilized with one or more additional switches and/or crossbar devices to form a new crossbar switch device, which may be larger than any one of the switch devices 700b. For example, as illustrated and discussed relative to FIG. 7C, the switch device 700b may be utilized with any other number of switch devices 700b (e.g., the nth switch device 700ac in FIG. 7C) and multiple analog crossbar switches 740 to form a new crossbar switch device.

The multiple first electronic devices 705 may be digital signal processors (DSPs) and/or the multiple second electronic devices 710 may be analog circuit switch integrated circuits (ICs) for use with electrical signals. Alternatively, or additionally the multiple second electronic devices 710 may be analog optical circuit switch ICs for use with optical signals. The multiple first electronic devices 705 may be individually configured to support one or more layer of the open systems interconnection (OSI) model. For example, each of the multiple first electronic devices 705 may be configured to support layer 1 protocols, layer 2 protocols, and/or layer 3 protocols with respect to the in-band traffic 720 and/or the out-of-band traffic 725.

Each, or at least one, of the multiple first electronic devices 705 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 705 may be able to adjust the way in which traffic is directed through it, such as in response to a command from the switch controller 715. For example, each of the multiple first electronic devices 705 may be operable to configure an internal switch, an external switch, or a crossbar based on the various layer protocol processing to be performed.

The first DSP device 705a may receive a communication that includes a frame header (or a packet header) and the first DSP device 705a may be configured to detect the frame header and decode the frame header along with any associated contents of the communication, all within the first DSP device 705a. In a second example, the first DSP device 705a may integrate a media access control (MAC) address lookup table which may allow the first DSP device 705a to configure one or more crossbars such that the first DSP device 705a may facilitate connectivity between any two MAC addresses that are included in the lookup table. Alternatively, or additionally, each of the first electronic devices 705 may include a lookup table that may store equalization settings that may be used for various connections between the first electronic devices 705 and other components within the switch device 700b. The equalization settings in the lookup table may be used to accelerate acquisition and/or tracking for a particular DSP device of the multiple first electronic devices 705 when the particular DSP device switches connections within the switch device 700b.

The multiple first electronic devices 705 may be configured to respond to layer 2 protocol requests and/or layer 3 protocol requests for connectivity and/or resource grant requests. For example, the multiple first electronic devices 705 may compare a request to a lookup table that includes priority levels and the multiple first electronic devices 705 may be operable to configure themselves and/or associated crossbars and/or switches based on the determined priority level. Alternatively, or additionally, each of the multiple first electronic devices 705 may be configured to respond to in-band requests (e.g., granting a connection request, signaling backpressure to the device 730, etc.), collect statistics on traffic handled by the multiple first electronic devices 705 (e.g., link utilization and/or traffic type), and/or perform data filtering (e.g., detecting a particular header, performing routing, generating flags and/or interrupts, and/or logging any of the filtering events).

The multiple first electronic devices 705 may be configured to communicate with (e.g., transmit data to and/or receive data from) the device 730. The communication with the device 730 may include in-band traffic 720. In such instances, the communications between the multiple first electronic devices 705 and the device 730 may be line-side communications, where the lines may facilitate communications using various communication channels. For example, the line-side communications between the multiple first electronic devices 705 and the device 730 may be an electrical-to-electrical connection, an optical-to-optical connection, an electrical-to-optical connection, or an optical-to-electrical connection, and so forth.

The device 730 may address communications directly to one of the multiple first electronic devices 705. For example, the device 730 may address communications to the second DSP device 705b. Alternatively, or additionally, the device 730 may address communications to the switch controller 715, which may then direct communications to the appropriate DSP device. For example, the device 730 may address communications intended for the second DSP device 705b to the switch controller 715 and the switch controller 715 may direct the communications to the second DSP device 705b.

The multiple first electronic devices 705 may individually include memory that may be used as a buffer for communications through the multiple first electronic devices 705. The memory in the multiple first electronic devices 705 may be utilized to buffer incoming and/or outgoing traffic, which may include in-band traffic 720 and/or out-of-band traffic 725. Due to the memory in the multiple first electronic devices 705 being distributed (e.g., by the distributed nature of the multiple first electronic devices 705), the switch device 700b may not include any memory for buffering in addition to the memory included in the multiple first electronic devices 705.

The multiple first electronic devices 705 may individually include one or more additional lanes that may be used for communications in the switch device 700b. Further details associated with the additional lanes are included in the description associated with FIG. 7C.

The multiple second electronic devices 710 may individually include one or more ports that may be used to facilitate communications within the switch device 700b, similar to the ports described relative to the multiple first electronic devices 705. Alternatively, or additionally, the lanes for communications between the multiple first electronic devices 705 and the multiple second electronic devices 710 may be coupled with the ports included in the multiple second electronic devices 710.

The switch controller 715 may be a microcontroller unit (MCU). Alternatively, or additionally, the switch controller 715 may be a DSP, or other processing device. The switch controller 715 may be communicatively coupled with at least the multiple first electronic devices 705 and/or the multiple second electronic devices 710. The switch controller 715 may resolve resource grant requests, distribute the network state to the multiple first electronic devices 705 and/or to the multiple second electronic device 710, and/or may establish and/or maintain timing among the components included in the switch device 700b.

The switch controller 715 may communicate with the multiple first electronic devices 705 and/or the multiple second electronic devices 710 using a separate connection/lane than the connections between the multiple first electronic devices 705 and the multiple second electronic devices 710. For example, the first connection between the multiple first electronic devices 705 and the multiple second electronic devices 710 may facilitate the in-band traffic 720 and the second connection between the switch controller 715 and the multiple first electronic devices 705 and/or the multiple second electronic devices 710 may facilitate the out-of-band traffic 725.

The out-of-band traffic 725 may use a different network than the in-band traffic 720. Alternatively, or additionally, the out-of-band traffic 725 may use a different physical layer protocol than the in-band traffic 720. The out-of-band traffic 725 may be used to manage and/or configure one or more components included in the switch device 700b. For example, the switch controller 715 may communicate with the multiple first electronic devices 705 using the out-of-band traffic 725 to reconfigure lanes and/or traffic routing based on the traffic through the switch device 700b.

The switch controller 715 may be programmable such that the switch controller 715 may be operable to dynamically map the lanes between the multiple first electronic devices 705 and the multiple second electronic devices 710. For example, in instances in which the first DSP device 705a includes a lane to the first analog IC 710a, the switch controller 715 may dynamically map the lane to be from the first DSP device 705a to the second analog IC 710b. The switch controller 715 may dynamically adapt the mapping of the lanes between the multiple first electronic devices 705 and the multiple second electronic devices 710 based on one or more conditions and/or a satisfaction of a threshold related to the conditions. For example, in instances in which the real-time data traffic in the switch device 700b (or an amount of real-time data traffic handled by one of the multiple first electronic devices 705 and/or one of the multiple second electronic devices 710) satisfies a threshold, the switch controller 715 may dynamically adapt the mapping of the lanes as described.

The switch device 700b may include one or more redundant lanes that may be used in various situations during operation of the switch device 700b. For example, one or more redundant lanes may be used for the out-of-band traffic 725, such as signaling using the out-of-band traffic 725. In such instances, the out-of-band signaling may be transmitted and/or received by a particular DSP device and/or by the switch controller 715, and the out-of-band signaling may be a lower transmission rate than the in-band traffic 720. In another example, one or more redundant lanes may be used for out-of-bandwidth broadcasts from the switch controller 715 and/or from one or more of the multiple first electronic devices 705 to other devices in the switch device 700b (e.g., such as other DSP devices).

The switch controller 715 may reserve a portion of bandwidth associated with the in-band traffic 720 in the switch device 700b. The bandwidth reserved by the switch controller 715 may be reserved on a per lane basis of the multiple lanes included in the switch device 700b. For example, a first lane between the first DSP device 705a and the first analog IC 710a may have a first reserved bandwidth and a second lane between the second DSP device 705b and the second analog IC 710b may have a second reserved bandwidth, where the amount of bandwidth reserved may be the same or may differ between the first reserved bandwidth and the second reserved bandwidth. The switch controller 715 may allocate resources within the switch device 700b based on predicted or anticipated traffic (e.g., based on a probabilistic model).

Alternatively, or additionally, the switch controller 715 may monitor the lanes of the multiple lanes in the switch device 700b. The switch controller 715 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 715 may dynamically remap a new lane in the switch device 700b to replace the degraded lane.

The switch controller 715 may perform adaptive signal equalization to the in-band traffic 720 in the switch device 700b. For example, the multiple first electronic devices 705 may provide feedback to the switch controller 715 relative to the workload handled by the multiple first electronic devices 705, and the switch controller 715 may adaptively manage workloads of the multiple first electronic devices 705 to optimize performance of the switch device 700b.

A backup switch controller (not illustrated) may be included in the switch device 700b. The backup switch controller may be a redundant controller relative to the switch controller 715. The backup switch controller may include the same or similar connections as the switch controller 715 relative to the multiple first electronic devices 705 and/or the multiple second electronic devices 710. The backup switch controller may perform the same or similar operations as the switch controller 715.

FIG. 7C illustrates an example switch device 700c. The switch device 700c may include a first DSP device 705a, an nth DSP device 705c, and multiple analog ICs 735. The first DSP device 705a may include a first auxiliary channel 707a, and a first out-of-band channel 709a. The nth DSP device 705c may include an nth auxiliary channel 707c, and an nth out-of-band channel 709c.

The first DSP device 705a, the nth DSP device 705c, and the multiple analog ICs 735 may be the same or similar as the first DSP device 705a, the nth DSP device 705c, and the multiple second electronic devices 710, respectively, of FIG. 7A and may be operable to perform the same or similar functions as described.

The auxiliary channels 707 (e.g., the first auxiliary channel 707a and the second auxiliary channel 707c) may be individually utilized by each of the DSP devices 705a, 705c as an additional lane for in-band traffic between at least the DSP devices 705a, 705c and the multiple analog ICs 735. The auxiliary channels 707 may be used to redundantly transmit in-band traffic relative to another lane included in the DSP devices 705a, 705c prior to a change in configuration to the corresponding DSP devices 705a, 705c. For example, in instances in which the first DSP device 705a includes a lane to a particular analog IC of the multiple analog ICs 735 and the first DSP device 705a is to be reconfigured (e.g., by a switch controller as described herein), the first auxiliary channel 707a may have a lane mapped to the particular analog IC such that the in-band traffic is redundant between the first DSP device 705a and the particular analog IC prior to reconfiguring the lanes associated with the first DSP device 705a (which reconfiguration may otherwise break the connection between the first DSP device 705a and the particular analog IC).

The auxiliary channels 707 may be used for communication between other near DSP devices. For example, in instances in which the first DSP device 705a is disposed spatially near to the nth DSP device 705c, the first DSP device 705a and the nth DSP device 705c may communicate with one another via the auxiliary channels 707. Such communications may be possible as the channels between near-neighbors may be relatively clean, such that physical layer processing may be simplified and may result in power reduction, latency reduction, a lesser amount of equalization, and/or other benefits to the switch device 700c.

The out-of-band channels 709 may be used to communicate the out-of-band traffic (e.g., the out-of-band traffic 725 of FIG. 7B) on a lane separate from the multiple lanes used to communicate in-band traffic. In such instances, the out-of-band channels 709 may not cause blocking or interference to the in-band traffic between at least the DSP devices 705a, 705c and the multiple analog ICs 735.

FIG. 7D illustrates an example aggregated switch device 700d. The aggregated switch device 700d may include a first switch device 700aa, an nth switch device 700ac, and multiple analog crossbar switches 740. The first switch device 700aa and the nth switch device 700ac may individually be the same or similar as the switch device 700b of FIG. 7B.

The aggregated switch device 700d illustrates that any number of the switch devices 700b (e.g., the first switch device 700aa and the nth switch device 700ac) may be aggregated into another switch device and/or connected to other analog crossbar switches. Each of the switch devices 700b may include multiple DSP devices and multiple analog IC and may be further aggregated into the aggregated switch device 700d using the multiple analog crossbar switches 740. As such, the aggregated switch device 700d may be scaled up or down for any size communication need, by adjusting the switch devices 700b and/or the multiple analog crossbar switches 740 to meet the communication demand.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

As used herein, the singular form of “a”, “an”, and “the” include plural references unless the context clearly dictates otherwise. As used herein, the statement that two or more parts or components are “coupled” shall mean that the parts are joined or operate together either directly or indirectly (i.e., through one or more intermediate parts or components, so long as a link occurs). As used herein, “directly coupled” means that two elements are directly in contact with each other. As used herein, “fixedly coupled” or “fixed” means that two components are coupled so as to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them. As utilized herein, “substantially” means that any difference is negligible, or that such differences are within an operating tolerance that are known to persons of ordinary skill in the art and provide for the desired performance and outcomes as described in one or more examples herein. Descriptions of numerical ranges are endpoints inclusive.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality). Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

Examples described as being implemented in hardware should not be limited thereto, but can include examples implemented in software, or combinations of software and hardware, and vice-versa, as will be apparent to those skilled in the art, unless otherwise specified herein. In the examples described herein, an example showing a singular component should not be considered limiting; rather, the invention is intended to encompass other examples including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A switch device, comprising:
a first electronic device comprising a plurality of ports operable to facilitate communication via a plurality of lanes;
a plurality of second electronic devices comprising a second plurality of ports, wherein the second electronic devices are operable to communicate with the first electronic device via the plurality of lanes; and
a switch controller operable to:
dynamically map the plurality of lanes from at least one port of the first electronic device to one or more ports of the second plurality of ports of the plurality of second electronic devices;
facilitate simultaneous broadcasting of data from the at least one port of the first electronic device to a plurality of ports of the second electronic devices; and
enable multicasting by selectively mapping data from the at least one port of the first electronic device to a predefined subset of ports in the second electronic devices.

2. The switch device of claim 1, wherein the switch controller is operable to:
dynamically monitor real-time traffic across the plurality of lanes; and
adjust mappings to optimize bandwidth allocation during broadcasting or multicasting operations while facilitating minimal latency and jitter.

3. The switch device of claim 1, further comprising:
a third electronic device comprising a third plurality of ports operable to facilitate communication via the plurality of lanes,
wherein the third electronic device is operable to relay broadcasted or multicast data to additional devices.

4. The switch device of claim 3, wherein the switch controller is operable to:
dynamically map data from at least one port of the third electronic device to multiple ports of the second electronic devices for multicasting; and
synchronize data delivery between the third electronic device and the second electronic device.

5. The switch device of claim 1, wherein the switch controller is further operable to:
implement adaptive load balancing during broadcasting to distribute traffic evenly across available lanes, preventing resource contention; and
dynamically reallocate lanes for broadcasting or multicasting in response to detected congestion or fault conditions.

6. The switch device of claim 1, wherein the switch controller is operable to synchronize:
multicasting operations across the plurality of lanes to facilitate receiving data with minimal jitter and delay; and
broadcasting operations to facilitate delivery of data to targeted ports.

7. The switch device of claim 6, wherein the synchronization comprises:
clock alignment across the first electronic device, the second electronic devices, and the plurality of lanes; and
buffering mechanisms to equalize data arrival times at different ports.

8. The switch device of claim 1, wherein the switch controller is operable to reduce overhead during broadcasting and multicasting by:
compressing data streams before transmission;
caching frequently broadcasted data to reduce redundancy; and
allocating reserved bandwidth for high-priority multicast or broadcast traffic.

9. The switch device of claim 1, wherein the dynamic mapping performed by the switch controller is operable to:
optimize energy efficiency by deactivating unused lanes during idle periods; and
reroute, based on a detected lane failure, data through one or more redundant lanes.

10. The switch device of claim 1, further comprising:
a feedback loop from the second electronic devices to the switch controller, wherein the feedback loop is used to dynamically adjust mappings based on signal quality, traffic congestion, or device priorities.

11. The switch device of claim 1, wherein the communications facilitated by the plurality of lanes comprise:
bidirectional data exchange, including transmission and receipt of data, during broadcasting and multicasting operations.

12. The switch device of claim 1, wherein the predefined subset of ports for multicasting is determined based on one or more of real-time traffic analysis, one or more routing rules within the switch controller, or user-defined configurations.

13. A method, comprising:
dynamically mapping, by a switch controller, a plurality of lanes from at least one port of a first electronic device to one or more ports of a second plurality of ports of a plurality of second electronic devices;
facilitating simultaneous broadcasting of data from the at least one port of the first electronic device to a plurality of ports of the plurality of second electronic devices; and
enabling multicasting by selectively mapping data from the at least one port of the first electronic device to a predefined subset of ports in the plurality of second electronic devices.

14. The method of claim 13, further comprising:
dynamically monitoring real-time traffic across the plurality of lanes; and
adjusting mappings to optimize bandwidth allocation during broadcasting or multicasting operations while facilitating minimal latency and jitter.

15. The method of claim 13, further comprising relaying broadcasted or multicast data from a third electronic device to additional devices.

16. The method of claim 15, further comprising:
dynamically mapping data from at least one port of the third electronic device to multiple ports of the second electronic devices for multicasting; and
synchronizing data delivery between the third electronic device and the second electronic device.

17. The method of claim 13, further comprising:
implementing adaptive load balancing during broadcasting to distribute traffic evenly across available lanes to prevent resource contention; and
dynamically reallocating lanes for broadcasting or multicasting in response to detected congestion or fault conditions.

18. The method of claim 13, further comprising:
synchronizing multicasting operations across the plurality of lanes to facilitate receiving data with minimal jitter and delay; and
synchronizing broadcasting operations to ensure delivery of data to targeted ports.

19. The method of claim 13, further comprising reduce overhead during broadcasting and multicasting by:
compressing data streams before transmission;
caching frequently broadcasted data to reduce redundancy; and
allocating reserved bandwidth for high-priority multicast or broadcast traffic.

20. The method of claim 13, wherein the predefined subset of ports for multicasting is determined based on one or more of real-time traffic analysis, one or more routing rules within the switch controller, or user-defined configurations.
